(19) United States
(12) Patent Application Publication
(10) Pub. No.: US 2010/0051382 A1
(43) Pub. Date: Mar. 4, 2010

(54) FALL ARREST SYSTEM FOR CLIMBERS OF A WOODEN STRUCTURE

(75) Inventor: Daniel M. Schlief, Winston, GA (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: The Southern Company, Atlanta, GA (US)

(21) Appl. No.: 12/542,285

(22) Filed: Aug. 17, 2009

Related U.S. Application Data
(60) Provisional application No. 61/091,758, filed on Aug. 26, 2008.

(51) Int. Cl. A62B 35/00

(52) U.S. Cl. 182/9

(57) ABSTRACT

A fall arrest system is adapted to prevent the falling of a lineman/pole climber from a wooden structure. The fall arrest system is connectable to a body belt of the climber, which is strapped about the waist of the climber. The fall arrest system includes at least two outer straps and at least two bias members, or springs, in communication thereto for on-the-fly adjustment of a loop to surround the wooden structure to be climbed.

### CROSS REFERENCE TO RELATED APPLICATION

This application claims benefit under 35 U.S.C. §119(e) of U.S. Provisional Patent Application Ser. No. 61/091,758 filed 26 Aug. 2008, the entire contents and substance of which is hereby incorporated by reference.

### BACKGROUND

Embodiments of the present invention relate to a safety device and, more particularly, to a fall arrest system for climbers of a wooden structure.

Injuries sustained by linemen and pole climbers falling from a wooden structure are, unfortunately, rather commonplace. As a result, many devices have been developed to prevent linemen and pole climbers from falling from a wooden structure, such as a wooden power pole or a wooden tree. For example, conventional solutions include the Buckingham BuckSqueeze wood pole fall protection system and the Pole Choker 3.

One such conventional solution includes a safety strap assembly connected to a climber's body belt. The safety strap assembly includes a pole strap having two ends with a loop extending from a base plate attached to the body belt. The loop can be opened to allow the user to respectively engage and disengage the loop from the wooden structure.

In operation, the safety strap assembly enables the lineman or pole climber to push the pole strap up or down the pole as he ascends or descends the pole. In the event the lineman loses his footing on the pole, a tugging force applied by the body, allows the tightening of the loop of the pole strap. In response, the pole strap will then tighten about the pole and prevent a fall.

Although the conventional safety strap assembly works to prevent a fall in the course of normal operation, it has at least three major drawbacks. First, the safety strap depends on the weight of the lineman/pole climber. Second, the safety strap does not allow the lineman to twist his body while he is working. Should the lineman twist his body using this safety strap assembly, the body strap will release and tighten the loop of the pole strap. The lineman would then have to readjust the pole strap in order to ascend and descend the pole. In the normal course of a work shift, the lineman would be required to adjust and readjust this safety strap assembly too many times for reasonable comfort and control. Third, and probably most importantly, the safety strap assembly does not protect the lineman when he has to maneuver around obstacles.

### SUMMARY

Briefly described, in an exemplary embodiment of the present invention, a fall arrest safety assembly is adapted to prevent linemen/pole climbers (herein collectively “climber”) from falling from a wooden structure, such as a power pole or a tree. The fall arrest safety assembly, or the fall arrest system, is couplable to a belt, which is secured about the waist of the climber.

In an exemplary embodiment, the fall arrest system includes a plurality of outer straps; an inner strap; a plurality of adjustable buckles; a plurality of bias members; and a plurality of attachment straps to attach to the climber's belt.

A first outer strap includes a first end and a second end. The first end of the first outer strap is floating, i.e., not coupled to anything. A first adjustable buckle is floatable about a portion of a length of the first outer strap. In one embodiment, the first adjustable buckle can travel along the first outer strap from the first end to a first fixed point. The first fixed point is a first end of a first bias member holder, which is coupled to the first outer strap. A first bias member, e.g., a spring, can be disposed within the first bias member holder. The first bias member holder extends from approximately the first fixed point to a second fixed point. In some embodiments, both the first and second fixed points are the coupling points between the first bias member holder and the first outer strap. A second adjustable buckle is coupled in proximity to the second end of the first outer strap.

A second outer strap also includes a first end and a second end. A third adjustable buckle is coupled in proximity to the first end of the second outer strap. A second bias member can be disposed within a second bias member holder. The second bias member holder extends from approximately the third fixed point to a fourth fixed point, which is in proximity to the second end of the second outer strap. In some embodiments, both the third and fourth fixed points can be the coupling points between the second bias member holder and the second outer strap. The first adjustable buckle is coupled to the second outer strap and in communication with the first outer strap, e.g., the first adjustable buckle can receive the first outer strap.

An inner strap extends from a first floating strap connector, which can float between approximately the second fixed point and approximately the second end of the first outer strap, and the second floating strap connector, which can float along a portion of the length of the second outer strap, e.g., between approximately the third adjustable buckle and approximately the third point. Each floating strap connector can include a quick coupling mechanism, to which first and second ends of the inner strap can be connected. Collectively, the first outer strap, the second outer strap, and the inner strap form an adjustable loop that can encircle the wooden structure.

A first attachment strap and a second attachment strap are connectable to the body belt of the climber. The first attachment strap includes a first connecting mechanism, which is connectable to a first D-ring of the body belt, at a first end, and a locking means at the second end. A portion of the first attachment strap is receivable by the third adjustable buckle, such that the length of the first attachment strap from the climber is adjustable. Likewise, the second attachment strap includes a second connecting mechanism, which is connectable to a second D-ring of the body belt, at a first end, and a locking means at the second end. A portion of the second attachment strap is receivable by the second adjustable buckle, such that the length of the second adjustment strap from the climber is adjustable. By varying the lengths of the first or second adjustable straps, the climber can control his angle and distance relative to the structure.

These and other objects, features and advantages of the present invention will become more apparent upon reading the following specification in conjunction with the accompanying drawing figures.

### BRIEF DESCRIPTION OF THE DRAWINGS

FIG. 1 illustrates a perspective view of a fall arrest system, in accordance with an exemplary embodiment of the present invention.

FIG. 2 illustrates a perspective view of the fall arrest system in use on a wooden structure, in accordance with an exemplary embodiment of the present invention.

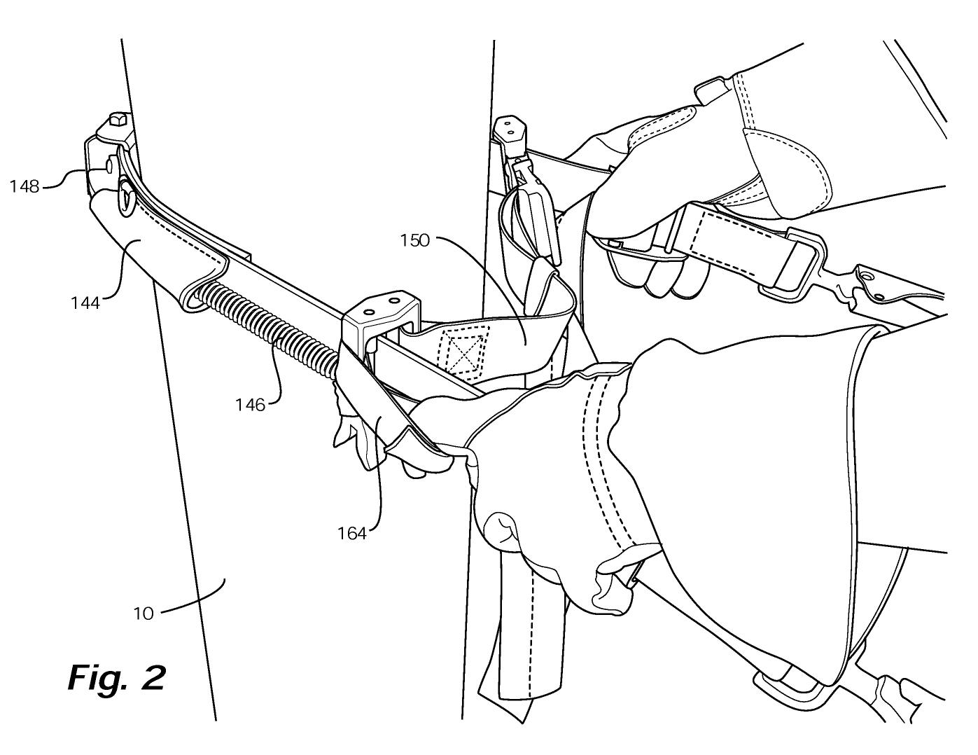

### DETAILED DESCRIPTION

Embodiments of the invention include several embodiments of fall arrest systems with improved features to prevent the falling of a climber. The fall arrest system generally includes a plurality of straps and buckles interconnected to encircle a climbing structure. The fall arrest system further includes at least two bias members for on-the-fly expansion of the loop created by the number of straps for quickly adjusting the size of the loop enabling hitchhiking up and down the structure.

Embodiments of the present invention allows a climber to ascend or descend a structure safely, but in the event of a cutout, which is a leading cause of injuries to climbers, an obstruction, or an obstacle, the fall arrest system can automatically tighten around the structure to prevent a fall.

The components and materials described hereinafter as making up various elements of the invention are intended to be illustrative and not restrictive. Many suitable components and materials that would perform the same or similar functions as the components and materials described herein are intended to be embraced within the scope of the invention. Such other components and materials not described herein can include, but are not limited to, for example, similar components and materials that are developed after development of the embodiments of the present invention.

Referring now to the figures, wherein like reference numerals represent like parts throughout the views, embodiments of the fall arrest system will be described in detail.

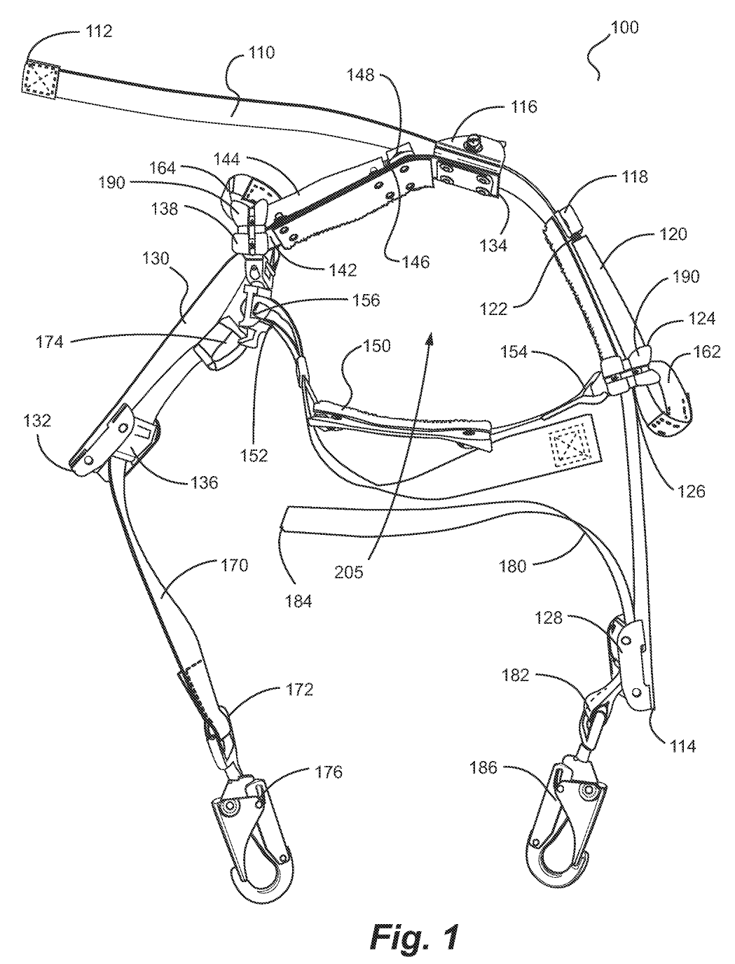

FIG. 1 illustrates a perspective view of an exemplary embodiment of a fall arrest system 100. The fall arrest system 100 is adapted to prevent the falling of a climber from a structure 10, which in some embodiments is predominately composed of wood. For example and not limitation, the structure 10 can be a vertical structure, e.g., a power pole, telephone phone, tree, and the like. Embodiments of the fall arrest system 100 are exemplarily connectable to a body belt (not shown) of the climber. The body belt is strapped about the waist of the climber.

The fall arrest system 100 includes a first outer strap 110; a second outer strap 130; and an inner strap 150. For connecting the straps 110, 130, and 150 to one another, the fall arrest system further includes a plurality of adjustable buckles. In addition, the fall arrest system 100 includes a plurality of bias member holders, each adapted to receive and secure at least one bias member. And for connecting the fall arrest system to a climber's belt, embodiments of the fall arrest system further include a plurality of attachment straps.

The first outer strap 110 includes a first end 112 and a second end 114. The first outer strap 110 is one of at least two outer straps of which a portion can be positioned on an opposing side (relative to the climber) of the structure 10 to climb. The portion of the first outer strap 110 in communication with the structure 10 is adjustable, i.e., the length of the first outer strap touching the wooden structure can be varied.

The first end 112 of the first outer strap 110 is floating, or not coupled to anything. A first securing mechanism 116 is floatable about a portion of a length of the first outer strap 110. In an exemplary embodiment, the first securing mechanism 116 is an adjustable buckle. More specifically, the adjustable buckle can be a cam buckle, which enables quick and secure securing. The first securing mechanism 116 can lock about the first outer strap 110 at a desired point between the first end 112 and a first fixed point 118. Varying the locking point of the first securing mechanism 116 along the first outer strap 110 can vary the amount of the first outer strap 110 in a touching relationship with the wooden structure.

The first fixed point 118 is a first end of a first bias member holder 120, which is coupled to the first outer strap 110. The first bias member holder 120 extends from the first fixed point 118 to a second fixed point 124. The first fixed point 118 and the second fixed point 124 can be the coupling points between the first bias member holder 120 and the first outer strap 110. A first bias member 122, e.g., a spring, can be disposed within the first bias member holder 120, and the first bias member 122 can be extended, as described more fully below.

A first floating strap connector 126 can be positioned between the second fixed point 124 and the second end 114 of the first outer strap 110. In proximity to the second end 114 of the first outer strap 110 is a second securing mechanism 128, e.g., a cam buckle.

The second outer strap 130 also includes a first end 132 and a second end 134. The second outer strap 130 is one of the at least two outer straps of which a portion can be positioned on an opposing side of the wooden object to climb. A third securing mechanism 136, e.g., a cam buckle, is coupled in proximity to the first end 132 of the second outer strap 130. A second floating strap connector 138 can travel along a portion of the length of the second outer strap 130, specifically between the third securing mechanism 136, which is near the first end 132 of the second outer strap 130, and a third fixed point 142. The third fixed point 142 is a first end of a second bias member holder 144. A second bias member 146 can be disposed within the second bias member holder 144. The second bias member holder 144 extends from and coupled to the third fixed point 142 to a fourth fixed point 148, which is in proximity to the second end 134 of the second outer strap 130. The first securing mechanism 116 is coupled to the second outer strap 130, near the second end 134, and in communication with the first outer strap 110.

In some embodiments, the first outer strap 110 is in communication with the second outer strap 130 via the first cam buckle 116. The first outer strap 110 incorporates the first bias member 122, or first spring. The second outer strap 130 incorporates the second bias member 146, or the second spring.

The inner strap 150 can extend from the first floating strap connector 126, about the first outer strap 110, at one end to the second floating strap connector 138, about the second outer strap 130 at a second end. At least one floating strap connector (126 and 138) can include a quick coupling mechanism 156, to which one of the first and second ends 152 and 154 of the inner strap 150 are connected. Collectively, the first outer strap 110, the second outer strap 130, and the inner strap 150 form an adjustable loop 205 for which the wooden structure to be climbed can be positioned therein. The quick coupling mechanism 156 enables the release of one end of the inner strap 150 from one of the outer straps, such that a portion the loop 205 can be opened for positioning about the wooden structure. For example, the quick coupling mechanism 156 can have releasable locking characteristics, similar to a seat belt, allowing the inner strap 150 to be releasably connected to the outer straps 110 and 130.

A first attachment strap 170 and a second attachment strap 180 enable the fall arrest system 100 to be connectable to the body belt (not shown) of the climber. The first attachment strap 170 includes a first connecting mechanism 176 at its first end 172, which is connectable to a first coupling mechanism, e.g., a D-ring, of the body belt. The second end 174 of the first attachment strap 170 can include a locking means (not shown). The first attachment strap 170 is receivable within the third securing mechanism 136, so the length of the first attachment strap 170 may be adjustable. This enables the climber to adjustable the length of one side relative to the structure 10. Likewise, the second attachment strap 180 includes a second connecting mechanism 186 at its first end 182, which is connectable to a second coupling mechanism, e.g., a D-ring, of the body belt. The second end 184 can include a locking means (not shown). The second attachment strap 180 is receivable within the second securing mechanism 128, so the length of the second attachment strap 180 is adjustable. This enables the climber to adjustable the length of one side relative to the structure 10.

Unlike the conventional, prior art solutions, embodiments of the fall arrest system 100 enable the tension in one or both of the bias members 122 or 146, or springs, to pull upon the inner strap 150 against the wooden structure. As a result, the fall arrest system 100 need not rely on the weight of the climber in order to prevent a fall. The characteristics of the bias member(s) assist with this task.

For example, the spring tension from the first and second bias members 122 and 146 are in communication with the inner strap 150, which can be a single piece of material. With the first and second bias members 122 and 146 connected to the inner strap 150, the spring tension provides a binding principle relative to the structure 10. For example, a first fingerloop 162 is coupled to an end of the first bias member 122 and a second fingerloop 164 is coupled to an end of the second bias member 146. When either of the fingerloops 162 or 164 is pulled, the particular bias member expands, which as a result causes the diameter of the loop 205 to increase. Also, the bias members 122 and 146 pull upon the inner strap 150, and the loop 205 loosens relative to the wooden structure. Consequently, the diameter of the loop 205—between the first outer strap 110, the second outer strap 130, and the inner strap 150—increases, because the bias member 122 and 146 stretches from the collapsed (relaxed) to an expanded state.

Also, unlike the conventional, prior art solutions, embodiments of the fall arrest system 100 do not require the altering of the length of the inner strap 150 to vary the size of the loop 205 about the wooden structure. Specifically, the length of the inner strap 150 is constant once set. The size of the loop 205 changes because of the expansion/contraction of at least one of the springs 122 and/or 146. Further, because the ends 152 and 154 of the inner strap 150 can float about the first and second floating strap connectors 124 and 138, the ends 152 and 154 of the inner strap 150 can move along the lengths of either or both of the first outer strap 110 and the second outer strap 130.

In one embodiment, the fall arrest system 100 includes the first outer strap 110, the second outer strap 130, and the inner strap 150. Varying the diameter of the loop 205 surrounding the structure 10, while not changing the length of the inner strap 150 is an advantage over the prior art. The springs 122 and 146 permit adjustment of the size of the loop 205. Also, having more than one bias member to vary the diameter of the loop 205 on the fly is helpful for a climber, and gives them enhanced control of climbing up and down a structure.

The plurality of cam buckles in communication with the first and second outer straps 110 and 130 allow ease of adjustment and permits adjustment of length of one of the outer straps. Instead of requiring the climber to twist his/her body and twist the body belt around for angling relative to the wooden structure, the ability to adjust one side independent of the other side is provided. The length of the attachment straps 170 and 180 is dependent on the amount one side of the climber wants to adapt his/her angle/distance relative to the wooden structure.

At least one advantage of having two separate outer straps 110 and 130, rather than just one, is that when the climber tightens the two outer straps 110 and 130, it takes the same amount of spring tension in either or both of the bias members 122 and/or 146 to release the inner strap 150 as it would on the larger diameter structure. In other words, by having two outer straps the climber can adjust to a smaller diameter structure on the fly, because it takes the same amount of tension to pull out on the bias member 122/146 as it would if the climber were pull on a large diameter structure. So independent of the size of the structure, the climber need only adjust the bias members 122/146 to move thereupon.

The fall arrest system 100 can further include a pair of teeth 190, each of which can be positioned near the first and second ends 152 and 154 of the inner strap 150. When a climber is positioned on the structure 10, the teeth 190 can engage or bite into the structure 10. In essence, the teeth 190 further stabilize the climber atop the structure 10.

In an exemplary embodiment, the materials used for the various straps 110, 130, 150, 170, and 180 can vary. For example, the materials can include a brown neoprene strap, or nylon, pregnated neoprene. Still other similar, exemplary materials can be used.

In some embodiments, the fall arrest system is adapted to surround a wooden structure 10 having a diameter of at a minimum of approximately 20 inches, and at a maximum of approximately 65 inches.

In an exemplary embodiment, a method of attaching the fall arrest system 100 to the structure 10 is provided. To attach to the structure 10, at least one of either the first connecting mechanism 176 or the second connecting mechanism 186 is coupled to the body belt of the climber, and the other is free, or not coupled to the body belt. The uncoupled connecting mechanism 176 or 186 is wrapped around the structure 10. In addition, the inner strap 150 is free, or not buckled at both ends to the outer straps 110, 130. The uncoupled inner strap is also wrapped around the structure. The quick coupling mechanism 152 of inner strap 150 is locked, and the uncoupled connecting mechanism 176 or 186 is coupled to the body belt. The inner strap 150 can be pulled tight to reduce the diameter of the loop 205, and bring the outer straps and inner strap as tightly around the structure as desired.

To shimmy up the structure 10, the fall arrest system 100 is first attached around the structure 10. Then, the climber can pull on one or both of the fingerloops 162, 164, which expands the diameter of the loop 205. Specifically, by pulling on a fingerloop 162, 164, the spring expands, and so does the diameter of the loop 205. With the loop 205 larger than the diameter of the structure 10, the climber can flip the outer straps 110 and 130 upwardly, just as with a conventional fall arrest system and with the conventional hitchhike method. When then climber has reached a desired point on the structure, the climber can release the fingerloops 162, 164, and the loop 205 becomes smaller and thus tighter around the structure. Advantageously, if the structure were to have a smaller diameter at its top, than at its bottom-where the initial diameter of the loop 205 was set, then the climber need only lean backwards and pull the inner strap 150 tighter to reduce the diameter of the loop 205.

From the foregoing, it can be seen that embodiments of the present invention provide a number of different fall arrest systems for preventing the falling of an individual ascending or descending a vertical structure, preferably made of wood.

Embodiments of the present invention can be embodied in other specific forms without departing from the spirit or essential characteristics thereof. For example, while embodiments of the invention have been described in the context of fall arrest system, the concepts described herein need not be limited to these illustrative embodiments.

Additionally, the specific configurations, choice of materials, and the size and shape of various elements can be varied according to particular design specifications or constraints requiring a fall arrest system constructed according to the principles of the invention. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A fall arrest system for climbing a wooden structure, the fall arrest system comprising:
a first outer strap;
a first adjustable buckle floatable about a portion of the length of the first outer strap, the first adjustable buckle is moveable along the first outer strap between approximately a first end of the first outer strap and approximately a first fixed point of the first outer strap;
a first bias member in communication with the first outer strap;
a second outer strap comprising a first end and a second end;
the first adjustable buckle coupled to the second end of the second outer strap and in communication with the first outer strap; and
an inner strap extending from in communication with the first outer strap and in communication with the second outer strap;
wherein the first outer strap, the second outer strap, and the inner strap collectively form a loop for engaging the circumference of the wooden structure.

2. The fall arrest system of claim 1, wherein the first adjustable buckle adjusts the length of the first outer strap in contact with the wooden structure.

3. The fall arrest system of claim 1, further comprising a second adjustable buckle coupled in proximity to a second end of the first outer strap.

4. The fall arrest system of claim 1, further comprising a third adjustable buckle coupled in proximity to the first end of the second outer strap.

5. The fall arrest system of claim 1, further comprising a second bias member in communication with the second outer strap.

6. The fall arrest system of claim 5, further comprising a first fingerloop in communication with the second bias member, the first fingerloop adapted to expand or contract the second bias member.

7. The fall arrest system of claim 1, further comprising:
a second adjustable buckle coupled in proximity to a second end of the first outer strap;
a third adjustable buckle coupled in proximity to the first end of the second outer strap;
a first attachment strap connectable to a first coupling mechanism of a body belt of a climber and receivable by the second adjustable buckle; and
a second attachment strap connectable to a second coupling mechanism of the body belt of the climber and receivable by the third adjustable buckle.

8. The fall arrest system of claim 7, wherein a portion of the first attachment strap is receivable by the second adjustable buckle, enabling the length of the first attachment strap to be adjustable by the climber.

9. The fall arrest system of claim 7, wherein a portion of the second attachment strap is receivable by the third adjustable buckle, enabling the length of the second attachment strap to be adjustable by the climber.

10. The fall arrest system of claim 1, further comprising a second fingerloop in communication with the first bias member, the second fingerloop adapted to expand or contract the first bias member.

11. The fall arrest system of claim 1, further comprising engaging teeth adapted to engage the wooden structure.

12. The fall arrest system of claim 5, further comprising:
a first bias member holder for housing the first bias member; and
a second bias member holder for housing the second bias member.

13. A fall arrest system for climbing a wooden structure, the fall arrest system comprising:
a first outer strap comprising a first end and a second end;
a first adjustable buckle floatable about a portion of the length of the first outer strap, moveable between the first end of the first outer strap and a first fixed point;
a first bias member in communication with the first outer strap in a relaxed state;
a second adjustable buckle coupled in proximity to the second end of the first outer strap;
a second outer strap comprising a first end and a second end;
a third adjustable buckle coupled in proximity to the first end of the second outer strap;
the first adjustable buckle coupled to the second end of the second outer strap and in communication with the first outer strap;
a second bias member in communication with the second outer strap in a relaxed state;
an inner strap extending from a first floating connector and a second floating connector;
a first attachment strap connectable to a first coupling mechanism of a body belt of a climber, wherein a portion of the first attachment strap is receivable by the third adjustable buckle, enabling the length of the first attachment strap to be adjustable by the climber; and
a second attachment strap connectable to a second coupling mechanism of the body belt of the climber, wherein a portion of the second attachment strap is receivable by the third adjustable buckle, enabling the length of the second attachment strap to be adjustable by the climber;
wherein the first outer strap, the second outer strap and the inner strap collectively form a loop engaging the circumference of the wooden structure.

14. The fall arrest system of claim 13, further comprising a first fingerloop in communication with the first bias member, the first fingerloop adapted to expand the first bias member from the relaxed state to an expanded state.

15. The fall arrest system of claim 13, further comprising a second fingergloop in communication with the second bias member, the second fingerloop adapted to expand the second bias member from the relaxed state to an expanded state.

16. The fall arrest system of claim 13, further comprising teeth adapted to engage the wooden structure.

17. A fall arrest system comprising:
a first outer strap;
a second outer strap;
a inner strap comprising a first end in communication with the first outer strap and a second end in communication with the second outer strap;
a first adjustable buckle in communication with the first outer strap and the second outer strap;
a first spring coupled to the first outer strap; and
a second spring coupled to the second outer strap;
wherein the first outer strap, the second outer strap, and the inner strap form a loop, and
wherein pulling on the first or second spring expands the spring and increases the diameter of the loop.

18. The fall arrest system of claim 17, further comprising a first fingerloop in communication with the first spring, the first fingerloop adapted to control the length of the first spring.

19. The fall arrest system of claim 17, further comprising a second fingerloop in communication with the second spring, the second fingerloop adapted to control the length of the second spring.

20. The fall arrest system of claim 17, further comprising a first attachment strap connectable to a body belt of a climber, the length of the first attachment strap relative the climber adjustable via a second adjustable buckle to enable the climber to rotate or twist while upon a wooden structure.
